(19) United States
(12) Patent Application Publication
(10) Pub. No.: US 2025/0176531 A1
(43) Pub. Date: Jun. 5, 2025

(54) Pest Blocker for Wildlife Feeder

(71) Applicant: David Wade Bushyhead, Skiatook, OK (US)

(72) Inventor: David Wade Bushyhead, Skiatook, OK (US)

(21) Appl. No.: 18/525,288

(22) Filed: Nov. 30, 2023

(51) Int. Cl. A01M 29/34; A01K 5/02

(52) U.S. Cl. CPC A01M 29/34; A01K 5/0225

(57) ABSTRACT

A device and method of use for a pest blocking apparatus for use in wildlife feeders. Wildlife feeders are used for various purposes and are primarily used in certain times of year or seasons and are unused for periods of time. Pests such as wasps and other stinging creatures will take up residence in these feeders in times of light or nonuse. This device is designed to mitigate the entry or residence of pests into or on these feeds.

### CROSS REFERENCE TO RELATED PATENT APPLICATIONS

This application claims priority to U.S. Provisional Patent Application 63/428,770 filed on Nov. 30, 2022.

### BACKGROUND

### Field of Use

Feeders for wildlife are utilized by many in the wildlife and hunting industries. These feeders are usually permanent or semi-permanent structures that the wildlife learn or know to go to for a food source. There is a part of the year where food is plentiful and the feeders are not used. During this time, the feeders are left empty. Wasps and other pests will take up residence and establish nests in openings and empty spaces of these feeders. This device is to mitigate the entry of wasps and other bugs or pests into a seasonal outdoor feeder when the feeder is not in use. This device can be applied to multiple types of feeders including grain and pellet style feeders as well as protein or powder style feeders.

### Background of Prior Art

Wildlife feeders are typically used for wildlife hunting and monitoring across the country. This type of supplemental feeding is used in many wildlife management programs and can provide nutritional benefits when resources are scarce. Feeders for animals which keep the feed in a storage portion, a funnel portion for the food to descend downward in a controlled manner, an opening for the food to exit or be consumed, and an optional spinner portion. The distributing portion can be gravity or timed fed. Gravity feeders provide the food continuously while timed feeders are set for specific times of day and may utilize a power source. Timed feeders can be directional or hanging. Hanging feeders hang from trees and are set to dispense food at certain times. Directional feeders are automatic and shoot food in a wide area via a spinning mechanism. All of these types of feeders are subject not only to the targeted wildlife they are meant to feed but are a target for unwanted pests of all shapes and sizes. Some feeders on the market have trapping and protection mechanisms to prevent large pests such as racoons and squirrels from eating the feed or getting into the storage portion. There aren't protections in place to prevent smaller pests such as wasps from getting into the feeders, especially when the feeders are empty or not in use. When deer feeders are empty and it is offseason, wasp will get in between the spinner plate and funnel on a deer feeder. Wasps will enter the feeders and build their nests in the feeders, which can be incredibly dangerous and problematic. Bug sprays can be used to mitigate the wasp removal but these sprays can be toxic and leave a residue on the feeders. Additionally, these sprays leave an odor that will often deter animals from approaching the feeders and consuming the feed. Currently there are not any practical non-toxic or odorless protections available to protect against wasps or other bugs from getting into feeders.

### DESCRIPTION

Disclosed herein is a device that mitigates the entry of wasps and other bugs from invading and/or building nests in the wildlife feeder. This device will fill and block the opening and keep the feeder free of pests and their nests. All elements of the device can be modified to accommodate many different types of feeders. This device generally applies to deer feeders. This device generally could also apply to other types of outdoor feeders.

Feeders generally have a vessel at the top of the device to store the feed, a funnel portion, an opening for food to be consumed or distributed, and, on some types of feeders, a spinner portion to further distribute the feed. Some types of feeders are adjustable at the distance between the spinner plate and the funnel. In one embodiment of the device, the adjustability allows for securing the device to be secured by tightening the space between the spinner plate and funnel. In another embodiment of the device, the device fits precisely into the feed distributing portion of the feeder. Insects, particularly wasps which can be aggressive, can get into the feeders when they are not in use and build their nests. This can be dangerous for users of the feeders. This invention solves the problem by blocking the opening or space between the distribution end and the storage compartment of the feeder. This invention covers the opening of the feeder so wasps and other insects cannot get into the feeder.

This invention provides a solution to pest control without the use of sprays or other types of bug repellants which would leave a scent or residue which could deter the animals the feeders are meant to attract.

It is an object of the present invention to mitigate the entry of wasps and building of subsequent nests on the opening of wildlife feeders. It is an object of the present invention to provide an alternative to using insect sprays and repellants. The objective in creating the present invention is to control the entry of wasps or other insects into feeders. It is an object of the present invention to optimize the use of the feeders by the intended or targeted animals and not pests. No other competitor, to our knowledge, has built a pest blocker for feeders. The biggest advantage of this invention is the use of non-chemical mechanisms.

This device comprises a hard or soft foam body layer and shape design to fill the open space of the specific type of feeder opening for existing feeders. Another advantage of the present invention is the simplicity of installation and removal.

This device can vary in size and shape according to the type of feeder it needs to be applied to. Sizes of the existing devices currently range from 2 inches to 5 inches in diameter but alternative embodiments and applications of the device could utilize a larger range of 1 inches to 10 inches or more. Shapes vary as well depending on application, polygonal or circular shapes are currently being utilized for the existing feeder types available but other shapes could also be utilized depending on innovations in feeder designs.

This invention is different from previous attempts in that it is easier to install and remains in place until removed. Additionally, there have been no other known and effective attempts to solve this issue. The device is engineered to particular size and shape from a main hard or soft foam portion. The device is used by placing it in the feeder during a time when one is not feeding the deer or other animals. When the time or season arrives to begin feeding the deer, the device is removed and regular use of the feeder resumes.

Optional elements include using a material alternative to foam such as silicone or other firm but semi moldable materials that won't leave a residue or stickiness.

The main purpose of this invention is to mitigate or prevent wasps and other pests from entering the feeder.

Although the invention has been described in detail with reference to several embodiments additional variations and modifications exist within the scope of the spirit of the invention as described.

Although the disclosed invention has been described with reference to various exemplary embodiments, it is to be understood that these embodiments are merely illustrative of the principals and application of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from considerations of the specification and practice of the invention disclosed herein. It is intended that the specification and examples be considered as exemplary only, with a scope and spirit being indicated by the claims.

Finally, it is noted that, as used in this specification and the appended claims, the singular forms “a”, “an”, and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

### DESCRIPTION OF THE DRAWINGS

FIG. 1 shows an embodiment of the device 10 with a shape for a feeder with a spinner.

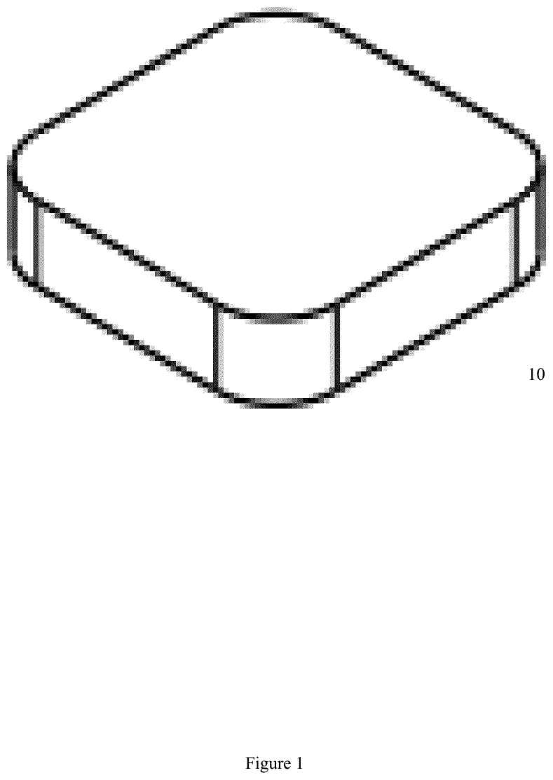

FIG. 2 shows an embodiment of the device 10 with a shape for a gravity or protein feeder.

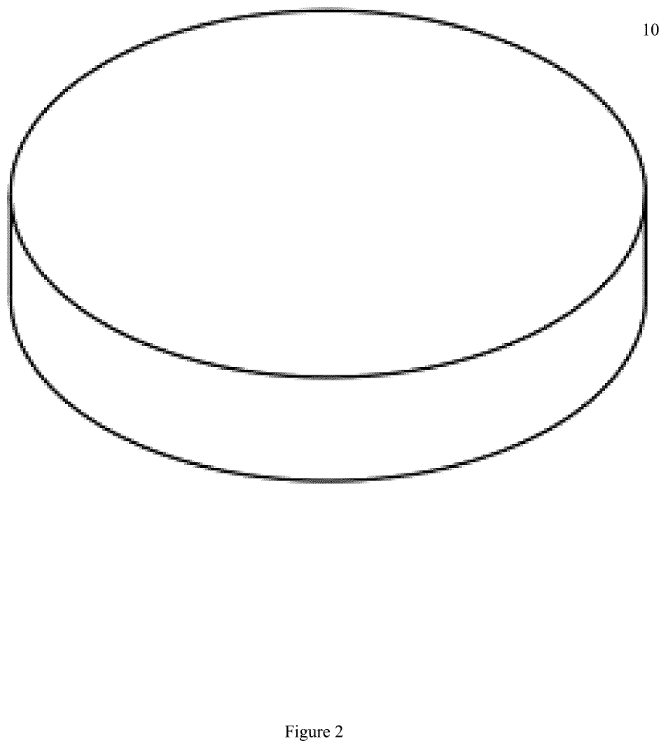

FIG. 3 shows an exploded view of the device's placement for a feeder with a spinner.

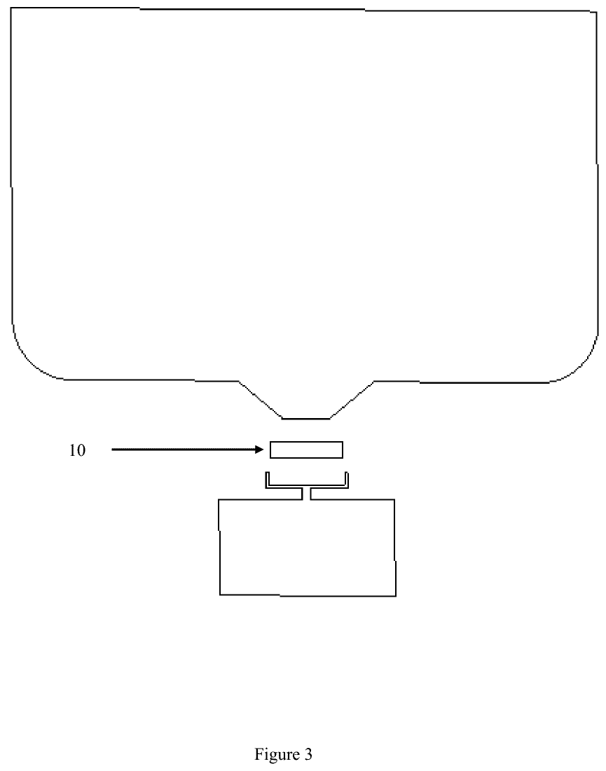

FIG. 4 shows an embodiment of the device 10 in a gravity or protein type feeder tube.

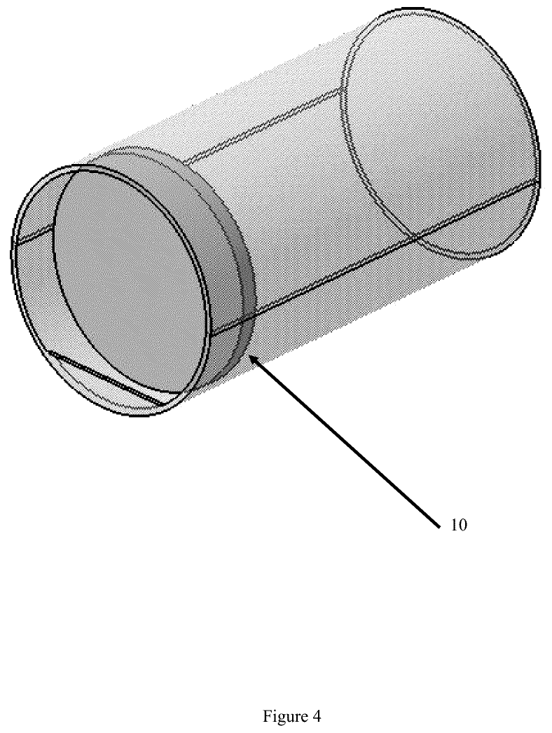

FIG. 5 shows an environmental view of the device 10 in a gravity or protein type feeder.

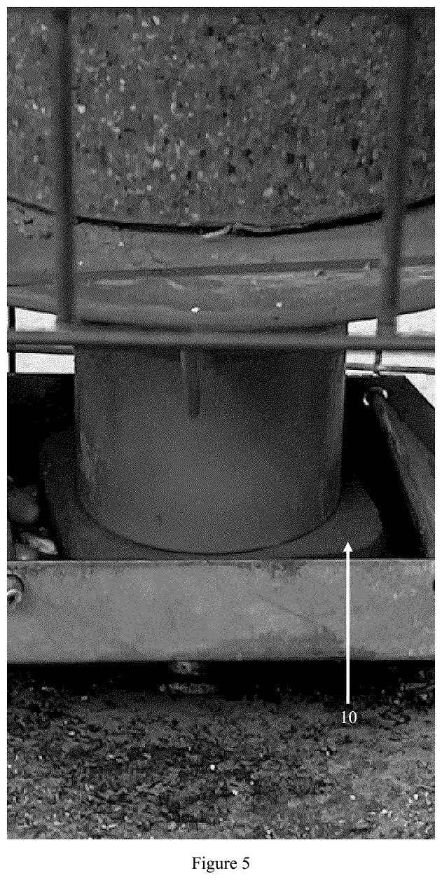

What is claimed is:

1. A device to mitigate pests from entering or nesting on or in an at least one or more wildlife feeding apparatus comprising: an at least one or more main body portion wherein said body portion has an at least one or more side portion and an at least one top and bottom portions.

2. The device of claim 1 wherein said at least one or more main body portion is shaped and sized for a wildlife feeder that has a spinning-type dispersing element.

3. The device of claim 1 wherein said at least one or more main body portion is shaped and sized for a wildlife feeder that disperses food by the natural force of gravity.

4. A method of using an at least one or more device to mitigate pests comprising: an at least one or more devices to mitigate pests from entering or nesting in or on an at least one or more wildlife feeding apparatus wherein said device is positioned so as to mitigate or block pests from entering or nesting in or on said at least one or more wildlife feeding apparatus.
